(19) United States
(12) Patent Application Publication
(10) Pub. No.: US 2016/0110277 A1
(43) Pub. Date: Apr. 21, 2016

(54) Method for Computer-Aided Analysis of an Automation System

(71) Applicant: Siemens Aktiengesellshaft, Muenchen (DE)

(72) Inventors: Zachery EDMONDSON, Los Angeles, CA (US); Hartmut LUDWIG, West Windsor, NJ (US); Dragan OBRADOVIC, Ottobrunn (DE); Andrei SZABO, Ottobrunn (DE); Lingyun WANG, Princeton, NJ (US)

(21) Appl. No.: 14/515,710

(22) Filed: Oct. 16, 2014

(51) Int. Cl. G06F 11/34; G06F 11/30; G06F 9/48

(52) U.S. Cl. CPC G06F 11/3409; G06F 9/4881; G06F 11/3024

(57) ABSTRACT

A method for computer-aided analysis of an automation system, where the automation system executes a number of jobs, each job being performed repetitively, wherein the execution durations of a respective job of the number of jobs for several repetitions of the respective job is determined to produce a plurality of execution durations, a statistical analysis on the plurality of execution durations is performed to produce at least one statistical quantity valid for the plurality of execution durations, and an action is performed for protecting the automation system and/or for generating a warning if a condition indicating an incorrect execution of the respective job is fulfilled for at least one statistical quantity.

### BACKGROUND OF THE INVENTION

1. Field of the Invention

The invention relates to automation systems and, more particularly to, a method and an apparatus for computer-aided analysis of an automation system.

2. Description of the Related Art

Automation systems are used in different industrial fields in order to automatically perform a plurality of tasks based on the execution of jobs, e.g., in a manufacturing process. Due to their complexity, automation systems need to be monitored to detect failures or malfunctions in the operation of the system. Conventionally, the instantaneous values of process variables are monitored in an automation system. However, as there are many components in an automation system (particularly actuators, sensors and control devices), the number of process variables is very high, making the monitoring and troubleshooting costly and complex.

### SUMMARY OF THE INVENTION

It is therefore an object of the invention to provide an easy and straightforward evaluation of an automation system to detect inconsistencies in the operation of the automation system.

This and other objects and advantages are achieved by providing a method in accordance with the invention by which a computer-aided analysis of an automation system is performed. In accordance with the invention, the automation system executes a number of jobs, each job being performed repetitively. Here and in the following, the number of jobs refers to those jobs that are analyzed in accordance with the method of the invention. However, the automation system may also include additional jobs which are not analyzed by the method of the invention.

In a first step of the inventive method, the execution durations of a respective job of the number of jobs are determined for several repetitions of the respective job, resulting in a plurality of execution durations. The execution duration indicates the time/time interval that is needed for executing the respective job.

In a second step, a statistical analysis of the plurality of execution durations is performed, resulting in one or more statistical quantities valid for the plurality of the execution durations. The term “statistical analysis” refers to an analysis summarizing information of the execution durations in the plurality of execution durations. If a condition indicating an incorrect or abnormal execution of the respective job is met for at least one statistical quantity, an action for protecting the automation system is performed and/or a warning is generated. Depending on the implementation, the action may be defined differently. In one embodiment, the action may be a shutdown or temporary stop of the section of the automation system performing the respective job or a shutdown or temporary stop of the overall automation system. Moreover, the action may refer to an appropriate measure to restart the correct execution of the respective job. The step of generating a warning refers to a generation of a signal associated with an incorrect execution. In a preferred embodiment, the warning is output at a user interface so that a human operator may observe the warning and initiate appropriate counter measures. However, the warning may also be stored in a digital storage which can be read out later, e.g., in a corresponding log file.

The invention is based on the finding that the statistics of the execution durations of repetitive jobs are well suited in order to detect inconsistencies during the execution of the jobs. The method of the invention is easy to implement because it is straightforward to detect execution durations for jobs in an automation system. Particularly, the method of the invention can be deployed without any problems in existing automation systems.

In a preferred embodiment of the invention, a statistical distribution of the execution durations is determined by the statistical analysis, the statistical distribution being the frequency distribution (histogram) of the execution durations or a probability distribution derived from the frequency distribution, where one or more statistical values with respect to the statistical distribution are derived as statistical quantities. Preferably, the one or more statistical values with respect to the statistical distribution comprise the mean value and/or the standard deviation, the variance, one or more higher moments of the statistical distribution. Those statistical values are well suited in detect an improper execution of the respective job.

In a preferred embodiment, the condition for the at least one statistical quantity is fulfilled if at least one statistical value with respect to the statistical distribution is outside a predetermined value range and preferably greater than a predetermined threshold. Particularly, the condition is fulfilled in cases that the standard deviation or the variance is greater than a predetermined threshold. In this case, there is a strong variation of the execution durations that is a good indicator that there are problems in the execution of the respective job.

In another embodiment of the invention, the trend of at least one statistical value with respect to the statistical distribution over consecutive time points of the repetitive executions of the respective job is determined, where the condition for the at least one statistical quantity is fulfilled if the trend of the at least one statistical value represents an increase or a decrease exceeding a predefined threshold. The above mentioned consecutive time points of the repetitive executions refer to time points at which the execution takes place (e.g., the start time or the finish time of the execution). Depending on the circumstances, the above condition may only be met for increasing trends or for decreasing trends. Alternatively, the condition may be met for both increasing and decreasing trends. Any known method may be used to determine a quantity describing the trend. Particularly, the trend may be represented by the mean derivative of a function fitted to the time evolution of the respective statistical value within the consecutive time points. In order to determine the time evolution, the statistical value is preferably calculated within time windows comprising a number of executions of the respective job, where the time window moves along with new executions of the respective job.

In another embodiment of the invention, the statistical analysis is such that a function is fitted to the dependency of the execution durations from consecutive time points of the repetitive executions of the respective job. The condition for the at least one statistical quantity is fulfilled if one or more parameters of the function fulfill a predetermined criterion. Those parameters are examples of statistical quantities. In this embodiment, the condition for the at least one statistical quantity is preferably fulfilled if the trend of the execution durations over the consecutive time points in accordance with the function represents an increase or decrease exceeding a preset threshold. Depending on the circumstances, this condition may only be met for increasing trends or for decreasing trends. Alternatively, the condition may be met for both increasing and decreasing trends. Any known method may be used to determine a quantity describing the trend. Particularly, the trend may be represented by the mean derivative of the function fitted to the dependency of the execution durations from the consecutive time points.

In a preferred embodiment of the invention, the above defined function that is fitted to the dependency of the execution durations from the consecutive time points is a polynomial with the time points of the repetitive executions of the respective job as variable and having one or more terms of ascending degrees, each term comprising a coefficient, where the condition for the at least one statistical quantity is fulfilled if one or more coefficients of the polynomial lie within a predetermined value range. In other words, the dependency of the execution durations from the consecutive time points is fitted by a function as follows:

f(t)=a+b·t+c·t²+d·t³+ Eq. 1

where t refers to the variable of the time points and where a, b, c, d etc. are the corresponding coefficients of the polynomial. By using a condition with respect to the coefficients, it may be determined if the dependency shows a predetermined type of trend (e.g., a linear or exponential increase or decrease).

In another embodiment of the invention, the respective jobs of the number of jobs are automatically scheduled based on the fulfillment of one or more logic conditions, i.e., the timing and particularly the start and the finish of the jobs are coupled to logic conditions that are verified by the automation system.

In a particularly preferred embodiment, the execution durations are measured by determining a time difference between the generation of a message starting the respective job and a generation of a message confirming that the respective job is finished, where the time difference is preferably derived from time stamps included in the messages. This is a very easy mechanism for determining the execution durations.

The method of the invention may be used in many different variants of automation systems. In a preferred embodiment, the method is performed in an automation system for manufacturing goods, particularly in an assembly line. Preferably, the assembly line is an assembly line for cars. However, the automation system may also be a system for generating and/or producing electric energy, i.e., a power plant and/or power grid.

Besides the above method, it is also an object of the invention to provide an apparatus for computer-aided analysis of an automation system where the automation system executes a number of jobs, each job being performed repetitively, wherein the apparatus comprises:

a means for determining the execution durations of a respective job of the number of jobs for several repetitions of the respective job, resulting in a plurality of execution durations;

a means for performing a statistical analysis on the plurality of execution durations, resulting in one or more statistical quantities valid for the plurality of execution durations; and

a means for performing an action for protecting the automation system and/or generating a warning if a condition indicating an incorrect execution of the respective job is fulfilled for at least one statistical quantity.

It should be understood that the automation system includes a processor or microprocessor, along with associated memory that are operatively coupled to the means. It should also be understood that the means can be provided separately within the automation system, or can be provided in the processor or microprocessor.

Preferably, the apparatus of the invention is configured to perform the method in accordance with one or more preferred embodiments of the invention.

It is also an object of the invention to provide an automation system, where the automation system is configured to execute a number of jobs during operation, each job being performed repetitively. The automation system comprises the above described apparatus of the invention or one or more preferred embodiments of the above described apparatus.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, embodiments of the invention will be described in detail with respect to the accompanying drawings, in which:

FIG. 1 is a schematic flow diagram showing the essential steps of a method in accordance with an embodiment of the invention; and

FIG. 2 is a schematic diagram illustrating an apparatus for performing the method as shown in FIG. 1.

### DETAILED DESCRIPTION OF THE PREFERRED EMBODIMENTS

The invention is described in the following with respect to jobs that are scheduled in an automation system based on logic conditions. An example of an automation system in which the invention may be used is an assembly line for assembling cars. In this assembly line, a plurality of actuators perform corresponding actions, e.g., mounting parts at a car or transporting the car body to different stations along the assembly line.

A typical scenario of scheduling jobs in an assembly line is as follows. When a first logic condition is fulfilled, a command is sent to a first actuator (for example, a robot) to execute a first job, e.g., to mount the front left car door to the car body. When sensors monitoring the first job confirm that the first job is finished, the command is issued that another actuator (e.g., another robot) shall execute a second job, e.g., to mount the rear left car door.

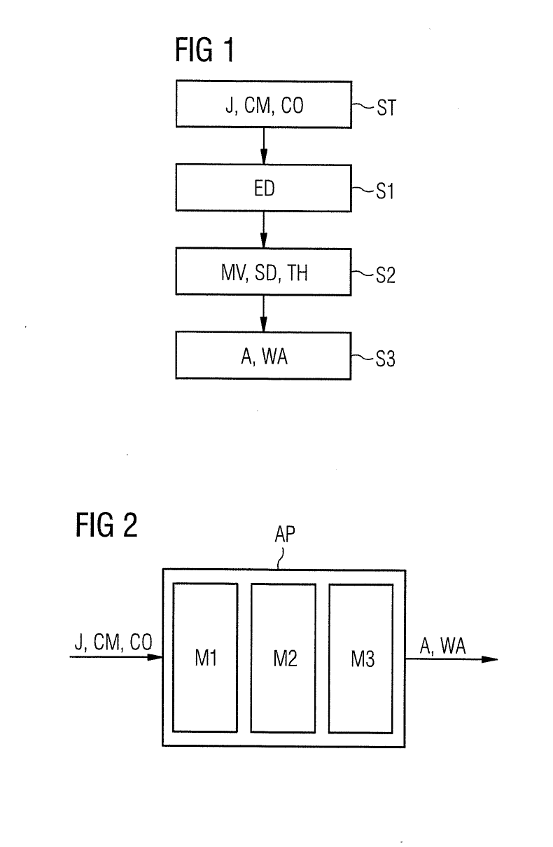

The flow chart of FIG. 1 illustrates an embodiment of the invention based on a job J performed in an automation system, where the job is started by the generation of a command CM, and where the job is stopped by the generation of a confirmation CO. The job is repetitively executed in the automation system. The commands and confirmations for the repetitive executions of the job J form the starting point ST of the method in FIG. 1.

In step S1 of the method, the execution durations ED for several repetitive executions of the job J are measured. To do so, the corresponding time differences between the generation of the command CM starting the job J and the generation of the confirmation CO stopping the job J are determined. In a preferred embodiment, the commands CM and the confirmations CO are time stamped so that the respective time difference is calculated based on the difference between the time stamp of a command CM and the time stamp of a corresponding confirmation CO.

After having calculated a plurality of execution durations ED for past executions of the job J, a statistical analysis is performed in step S2 to determine statistical values valid for the plurality of execution durations ED. In the embodiment described herein, the frequency distribution of the execution durations ED is calculated. The mean value MV and the standard deviation SD are derived from this frequency distribution as statistical values. It is the aim of the invention to detect circumstances indicating an improper or incorrect execution of the respective job, i.e., circumstances that indicate possible problems in the process performed by the automation system (e.g., in a manufacturing process). To do so, a predetermined threshold TH is used in the embodiment described herein. If the standard deviation SD exceeds this predetermined threshold TH, circumstances of an incorrect execution are detected. In other words, if the standard deviation SD is very high, this is an indication that there is a strong variation of the execution durations of the job that is an appropriate hint that there are some problems in the execution of this job.

In case the standard deviation SD exceeds the threshold TH, step S3 of FIG. 1 is performed. According to this step, an appropriate action A for protecting the automation system is initiated. An example of such an action may be temporary stoppage of the section in the automation system executing the job. Additionally or alternatively, a corresponding warning WA may be issued in the automation system. Particularly, this warning is output at a terminal within the automation system, e.g., at a terminal in a control center of the automation system. This warning is observed by a human operator who may then check the section of the automation system executing the job and initiate appropriate counter measures.

In another embodiment of the invention, the mean value MV may also be compared with an appropriate threshold. A very large execution time may be an indication of a problem in the job, so that an action A or a warning WA may also be generated in cases in which the mean value MV exceeds a threshold.

The statistical values MV and SD need not be compared directly with a threshold value to determine an incorrect operation. It is also possible that trends over time of these statistical values are processed. To do so, the statistical values are determined within preset time windows. For the executions in these time windows, a respective frequency distribution can be derived and the above mean value MV and standard deviation SD can be obtained for this frequency distribution. In a preferred embodiment, an improper operation of the automation system is detected for a case in which the trend of the standard deviation SD and/or the trend of the mean value MV represent an increase exceeding a certain threshold.

The above statistical values in form of the mean value MV and the standard deviation SD are only examples and other statistical quantities or values may also be processed in embodiments of the invention. For example, the statistical quantities may refer to parameters of a function fitted to the dependency of the execution durations from the time points of the respective executions, i.e., the points of time where the respective execution of the job is performed (e.g., started or finished). As described above, the function may be a polynomial fit where the coefficients of the terms of the polynomial are compared with a value range or threshold to determine an improper operation of the automation system.

The method of the invention may be implemented in a local controller associated with the section of the automation system executing the job to be analyzed by the invention. However, the method may also be implemented in a control center monitoring the overall operation of the automation system.

FIG. 2 shows an example of an apparatus performing the method of FIG. 1. The apparatus AP of FIG. 2 receives, for each execution of the job J, the command CM generated at the start of the job J and the confirmation CO generated at the end of the job J. The apparatus AP comprises a means M1 that performs step S1 of FIG. 1, i.e., which determines the execution durations ED based on time differences between the command CM and the confirmation CO. The means M2 of the apparatus AP performs step S2 of FIG. 1, i.e., the above described statistical analysis resulting in statistical values MV and SD. The means M3 performs step S3 of FIG. 1, i.e., this means determines whether the statistical values fulfill a condition with respect to an improper execution of the job J. If this is the case, an action A and/or a warning WA is output by the means M3.

The invention as described in the foregoing has several advantages. Particularly, an easy and straightforward monitoring of an automation system is provided by analyzing the statistics of the execution durations of jobs performed by the automation system. Due to the simplicity of this approach, it is easy to implement the method of the invention in existing automation systems.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for computer-aided analysis of an automation system executing a number of jobs, each job being performed repetitively, the method comprising:
determining execution durations of a respective job of the number of jobs for several repetitions of the respective job being performed on the automation system to produce a plurality of execution durations of the automation system;
performing a statistical analysis on the plurality of execution durations to produce at least one statistical quantity valid for the plurality of execution durations;
performing an action for at least one of (i) protecting the automation system and (ii) generating a warning if a condition indicating an incorrect execution of the respective job is fulfilled for the at least one statistical quantity.

2. The method according to claim 1, wherein a statistical distribution of the plurality of execution durations is determined by statistical analysis, the statistical distribution being a frequency distribution of the plurality of execution durations or a probability distribution derived from the frequency distribution, at least statistical values with respect to the statistical distribution being derived as statistical quantities.

3. The method according to claim 2, wherein the at least one statistical value with respect to the statistical distribution comprise at least one of (i) a mean value, (ii) a standard deviation, (iii) a variance and (iv) at least one higher moment of the statistical distribution.

4. The method according to claim 3, wherein the condition for the at least one statistical quantity is fulfilled if at least one of the statistical values is outside a predetermined value range.

5. The method according to claim 3, wherein the condition for the at least one statistical quantity is fulfilled if at least one of the statistical values is greater than a predetermined threshold.

6. The method according to claim 2, further comprising:
determining a trend of at least one statistical value over consecutive time points of repetitive executions of the respective job;
wherein the condition for the at least one statistical quantity is fulfilled if the trend of the at least one statistical value represents an increase or a decrease exceeding a predefined threshold.

7. The method according to claim 3, further comprising:
determining a trend of at least one statistical value over consecutive time points of repetitive executions of the respective job;
wherein the condition for the at least one statistical quantity is fulfilled if the trend of the at least one statistical value represents an increase or a decrease exceeding a predefined threshold.

8. The method according to claim 4, further comprising:
determining a trend of at least one statistical value over consecutive time points of repetitive executions of the respective job;
wherein the condition for the at least one statistical quantity is fulfilled if the trend of the at least one statistical value represents an increase or a decrease exceeding a predefined threshold.

9. The method according to claim 1, wherein the statistical analysis comprises fitting a function to the dependency of the plurality of execution durations from consecutive time points of the repetitive executions of the respective job; and
wherein the condition for the at least one statistical quantity is fulfilled if at least one parameter of the function fulfils a predetermined criterion.

10. The method according to claim 9, wherein the condition for the at least one statistical quantity is fulfilled if the trend of the plurality of execution durations over the consecutive time points according to the function represents an increase or decrease exceeding a preset threshold.

11. The method according to claim 9, wherein the function is a polynomial with time points of the repetitive executions of the respective job as variables and having at least one term of ascending degrees, each term comprising a coefficient; and
wherein the condition for the at least one statistical quantity is fulfilled if at least one coefficient of the polynomial lies in a predetermined value range.

12. The method according to claim 1, wherein the respective jobs of the number of jobs are automatically scheduled based on fulfillment of at least one logic condition.

13. The method according to claim 1, wherein each of the plurality of execution durations is measured by determining a time difference between generation of a message starting the respective job and generation of a message confirming that the respective job is finished, the time difference being derived from time stamps included in the messages.

14. The method according to claim 1, wherein the method is performed in one of (i) an automation system for manufacturing goods and (ii) an automation system for at least one of generating electric energy and producing electric energy.

15. The method according to claim 1, wherein the automation system is an assembly line.

16. An apparatus for a computer-aided analysis of an automation system executing a number of jobs, each job being performed repetitively, the apparatus comprising:
means for determining the execution durations of a respective job of the number of jobs for several repetitions of the respective job to produce a plurality of execution durations;
means for performing a statistical analysis on the plurality of execution durations to produce at least one statistical quantity valid for the plurality of execution durations;
means for performing an action for at least one of (i) protecting the automation system and (ii) generating a warning if a condition indicating an incorrect execution of the respective job is fulfilled for the at least one statistical quantity.

17. The apparatus according to claim 16, wherein the apparatus is configured to:
determine a statistical distribution of the plurality of execution durations by statistical analysis, the statistical distribution being a frequency distribution of the plurality of execution durations or a probability distribution derived from the frequency distribution, at least statistical values with respect to the statistical distribution being derived as statistical quantities.

18. An automation system, wherein the automation system is configured to execute a number of jobs during operation, each job being performed repetitively, the automation system comprising:
an apparatus for a computer-aided analysis of an automation system executing the number of jobs, each job being performed repetitively, the apparatus comprising:
means for determining the execution durations of a respective job of the number of jobs for several repetitions of the respective job to produce a plurality of execution durations of the automation system;
means for performing a statistical analysis on the plurality of execution durations to produce at least one statistical quantity valid for the plurality of execution durations;
means for performing an action for at least one of (i) protecting the automation system and (ii) generating a warning if a condition indicating an incorrect execution of the respective job is fulfilled for the at least one statistical quantity.
